(19) United States
(12) Patent Application Publication
(10) Pub. No.: US 2003/0187594 A1
(43) Pub. Date: Oct. 2, 2003

(54) Method for a geometrically accurate model of solute-solvent interactions using implicit solvent

(75) Inventors: Michael Alexander Sherman, Mountain View, CA (US); Erin Sander Catto, Alviso, CA (US); Daniel Joseph Filip, San Jose, CA (US)

Correspondence Address: Charles K. Sholtz, Protein Mechanics, Inc., 280 Hope St., Mountain View, CA, 94041, US

(73) Assignee: Protein Mechanics, Inc., Mountain View, CA

(21) Appl. No.: 10/371,173

(22) Filed: Feb. 21, 2003

Related U.S. Application Data
(60) Provisional application No. 60/358,637, filed on Feb. 21, 2002.
(60) Provisional application No. 60/358,660, filed on Feb. 21, 2002.

(51) Int. Cl. G06F 19/00

(52) U.S. Cl. 702/27

(57) ABSTRACT

Methods of obtaining directional information of a solvent-accessible surface of an atom or molecule are described. Also disclosed are methods for simulating the kinetic behavior of a solute molecule in a solvent are also described. The methods utilize a representation of the solvent-accessible surface of the solute molecule which includes information on the geometric orientation of the surface relative to the molecule, and using the representation in a corrected kinetic model to simulate the kinetic behavior of the solute molecule in the solvent.

### CROSS-REFERENCES TO RELATED APPLICATIONS

This application is entitled to the benefit of the priority filing date of Provisional Patent Application No. 60/358,637, filed Feb. 21, 2002, Provisional Patent Application No. 60/358,660, filed Feb. 21, 2002, and U.S. patent application Ser. No. ______, by Erin S. Catto, titled “Method for Providing Thermal Excitation to Molecular Dynamics Models”, filed on Feb. 21, 2003, all of which are hereby incorporated by reference.

### BACKGROUND OF THE INVENTION

The present invention is related to the field of molecular modeling and, more particularly, to computer-implemented methods for the dynamic modeling of solute molecules in a solvent environment.

Molecular modeling is concerned with mimicking the behavior of molecules and molecular systems, typically through the use of computers. Typical molecular modeling applications have included enzyme-ligand docking, molecular diffusion, reaction pathways, phase transitions, and protein folding studies. Researchers in the biological sciences and the pharmaceutical, polymer, and chemical industries are beginning to use these techniques to understand the nature of chemical processes in complex molecules and to design new drugs and materials accordingly.

In molecular dynamics, successive configurations of the molecule or molecular system are generated by integrating Newton's laws of motion. A molecule, such as protein, contains multiple bodies (atoms of the molecule or groups of such atoms) whose motions must be considered. Each of these bodies are subject to multiple and complex forces. Thus the calculation of the motion and the shape of the molecule involves the determination of the position and motion of each body of the molecule.

Furthermore, an accurate simulation of the behavior of a selected molecule, such as a peptide or protein, typically needs to account for the effects of the bulk medium, or “solvent”, which provides the environment for the molecule of interest. The solvent is typically an aqueous liquid (e.g., water) although it may comprise hydrophobic membranes, other organic or inorganic molecules, or mixtures of the above. Important solvent properties include electrostatic screening, cavitation effects, pH, local interactions with other molecules, viscosity, and the provision of a constant-temperature environment. Some or all the solvent's properties may vary spatially, so that the solvent could consist, for example, of an aqueous intracellular region, a hydrophobic membrane region, and an aqueous extracellular region. Temporal changes in solvent properties, such as temperature changes, may also occur.

The molecules interacting within the environment provided by the bulk solvent medium are referred to as the “solute” molecules, or just “solute”. A particular simulation may be set up to model a single solute molecule, such as a protein, or several interacting solute molecules, such as would appear in a protein/ligand or protein/protein interaction. In addition, the simulation may include an assortment of locally-interacting molecules, such as ions or explicitly modeled water molecules.

Bulk solvent behavior may be simulated in a computer with either an explicit or implicit solvent model. An explicit model consists of a very large number of individually-modeled solvent molecules, where the positions, orientations, and velocities of each explicit molecule are tracked and their interactions with one another as well as with the solute molecules are calculated. To obtain good bulk behavior this way typically requires thousands to hundreds of thousands of individual molecules to be tracked, and is therefore computationally expensive. In fact, the explicit solvent computation is usually by far the most expensive part of a molecular simulation.

An implicit solvent model can be considerably more efficient, because it is designed to model the aggregate effects of a bulk solvent's molecules on the solute without modeling the individual bulk molecules. There can still be some explicitly-modeled solvent molecules included in the system, but in this case they are considered solute molecules and are themselves affected by the bulk solvent medium in which they are embedded. Implicit solvent models can range from simple to complicated, depending on the application and desired fidelity (see, e.g., Cramer and Truhlar (1999) “Implicit Solvation Models: Equilibria, Structure, Spectra, and Dynamics”, Chem. Rev. 99:2161-2200; and Orozco and Luque (2000) “Theoretical Methods for the Description of the Solvent Effect in Biomolecular Systems”, Chem. Rev. 100:4187-4225).

Effective implicit solvent models are designed to account for a variety of effects on the solute that solvent is known to produce. These effects can be divided into (1) those which arise only from the position and orientation of the solute and solvent molecules and thus determine the system's potential energy, and (2) those which also involve the velocities of the solvent and solute molecules and thus determine the system's kinetic energy. The former are referred to as conservative effects, the latter as kinetic effects.

Conservative or potential effects include electrostatic screening, cavitation, and “first shell” effects such as the formation of van der Waals interactions and hydrogen bonds at the solvent/solute boundary. The energies associated with these effects can be considered the energetic “cost” of transferring the desolvated solute molecules, frozen in their current conformations and relative positions, from vacuum into the solvent. Note that the solvent's parameters (e.g. density, resistance to cavitation, propensity to form hydrogen bonds, etc) preferably reflect its behavior at temperature. Once modeled and parameterized against experiment or higher-order computation, the gradient of the resulting energy terms yields forces which can be used to drive molecular dynamics simulations. A number of implicit solvent models designed to model conservative effects are known in the art. They include the Generalized Born/Solvent Accessible (GB/SA) method (Tsui and Case (2001) Biopolymers, 56, 275-291), as well as others, described in, e.g., Simonson (2001) Curr. Opin. Struct. Biol. 11:243-252; Hassan & Mehler (2002) Proteins: Struct. Funct. Genet. 47:45-61; Lee, et al., (2002) J. Chem. Phys. 116:10606-10614; and Orzco, et al., (2000) Chem. Rev. 100:4187-4225.

Kinetic effects, when modeled implicitly, typically invoke a quantity referred to as the “solvent-accessible surface area”, described with reference to FIG. 1A. Large circles represent bodies 12 of a solute molecule. Small circles represent typical solvent molecules 14 in the first solvation shell (for water, these are generally represented as spheres of radius 1.4 Å). The heavy lines trace the shape produced by the solvent molecule centers as they are rolled along the surface of the solute. This shape is referred to as the solvent accessible surface 16 of the solute. Its area (length in two dimensions) is referred to as the solvent accessible surface area (“SASA”) and is proportional to the number of solvent molecules which may be present in the first solvation shell. It can be appreciated that the SASA for a body consisting of multiple atoms will be smaller than the sum of the SASAs of the individual atoms, since portions of each atom's surface will be “buried” in the interior of other atoms' accessible surface spheres. Empirically, most significant solvent effects are proportional to the SASA, so estimation of SASA is an important step in any implicit solvent model.

A number of approaches have been used to compute SASA. They include analytic algorithms, such as those described by, e.g., Fraczkiewicz & Braun (J. Comp. Chem. 19:319, 1998); Connolly (Journal of Applied Crystallography 16:548, 1983); Richmond J Mol. Biol. 178:63, 1984; as well as approximate algorithms (e.g., the algorithm described by Shrake and Rupley (J. Mol. Biol. 79:351-371, 1973); and the hybrid approximation algorithm by Lee & Richards (J. Mol. Biol. 55:379-400, 1971). In the algorithm of Shrake and Rupley, for example, 92 points were uniformly distributed on each spherical representation of an atom, and the SASA was calculated by counting the surface area represented by points that were not inside any other sphere. A summary of other methods that have been used to calculate SASA can be found, for example, in reviews by Richards, F. M. (Calculation of Molecular Volumes and Areas for Structures of Known Geometry. Methods in Enzymology 115, 440-464 (1985)) and Gerstein, M., F., et al., (Protein surfaces and volumes: measurement and use. In: Rossmann, M. G., and E. Arnold, editors. International Tables for Crystallography. Crystallography of Biological Molecules. Dortrecht, Netherlands: Kluwer Academic Publishers. p 531-45 (2001)). Although the methods cited above are effective for computing the SASA, they can be computationally-expensive, and do not provide information regarding the directionality or orientation of the solvent accessible surface. Embodiments of the present invention address these and other shortcomings of prior art approaches to calculating SASA.

Kinetic effects involve energy transfer between the solvent and solute due to non-zero relative velocities at the solvent/solute interface. These effects include both (i) the input of thermal (kinetic) energy from the constant-temperature bulk solvent to the solute surface, and (ii) the dissipation of solute kinetic energy via transfer to the solvent. The transfer mechanism is the same in both cases—collisions between the solute and solvent molecules. Since individual solvent molecules are not directly simulated in implicit solvent models, careful treatment is necessary to capture the desired effects correctly.

A mathematical description of kinetic effects in implicit solvent models preferably accounts for both the input and dissipation effects above, such that the solute molecules eventually reach thermal equilibrium with the solvent. Such a model incorporating both effects is sometimes called a “thermal model” in the literature; however it will be referred to herein as a kinetic model so that the term thermal model can be used to refer to the addition of kinetic energy from the solvent to the solute, and the term viscous model can be used to refer to the dissipation of a moving solute's kinetic energy (via damping or friction) into the solvent medium.

A commonly used kinetic model is the Langevin equation (Leach, A. R., Molecular Modeling, 1996, Addison Wesley, p. 349):

ma=F−mγ+R

where m is the body's mass, a is the body's acceleration, F is the gradient of the potential energy, γ is the solvent frequency, v is the body's velocity, and R is a stochastic force. The second and third terms to the right of the equal sign constitute the kinetic portion (or kinetic terms) of the model, and roughly represent the viscous damping and thermal interactions, respectively, with the implicit solvent. Although the first term to the right of the equal sign (F, the spatial gradient of the conservative energy effects) accounts properly for directional effects in those components of F which involve the solvent accessible surface, the kinetic terms lack all important geometric information—they account neither for target atoms that are unreachable by the solvent molecules, nor for the directionality of the solvent motion.

The Langevin equation, as well as other models used in molecular mechanics, can employ a SASA calculation to determine, for each atom in a molecule, what fraction of that atom is exposed to solvent. These calculations provide a scalar energy contribution factor for each atom, so it is not possible to determine which side of the atom faces the solvent, only the fraction which is exposed. The same SASA calculations can also be used in the computation of velocity-dependent non-conservative forces, namely viscous (or friction) forces and transfers of thermal kinetic energy from solvent to solute. Since these terms do not employ differentiation of the SASA, there is no opportunity to derive directional information. That means it is not possible to determine physically correct directionality for these forces, and in current practice directions are chosen randomly instead. This deviation from physically-accurate modeling can yield incorrect predictions of molecular behavior when molecular dynamics simulations are run. Embodiments of the present invention address these and other shortcomings of currently-available implicit solvent kinetic models used in molecular dynamics simulations.

### SUMMARY OF THE INVENTION

In one aspect, the present invention provides a geometrically accurate kinetic model for implicit solvents that takes into account the geometry and orientation of the solute when applying kinetic effects during a molecular dynamics simulation.

In a general embodiment, the invention provides a method of simulating kinetic behavior of a solute molecule in a solvent. The method includes the steps of (i) providing a representation of a solvent-accessible surface of the solute molecule, wherein the representation includes information on the geometric orientation of the surface relative to the molecule, and using the representation in a corrected kinetic model to simulate the kinetic behavior of the molecule in the solvent.

In one embodiment, the corrected kinetic model comprises applying one or more impulses to the solvent-accessible surface, and the impulses represent solvent-solute interactions. In an alternate embodiment, the corrected kinetic model comprises applying one or more forces to the solvent-accessible surface, and the forces represent solvent-solute interactions. For example, the corrected kinetic model may comprise a step of calculating total randomized forces ^{b}Rⱼ on patches corresponding to locations on the solvent-accessible surface.

In another embodiment, the representation comprises one or more solute molecule surface normal vector(s). In a related embodiment, the representation comprises one or more directional solvent-accessible surface(s). In still another embodiment, the corrected kinetic model comprises a step of calculating viscous collision speeds for locations on the solute molecule represented by the surface normal vectors. In another embodiment, the corrected kinetic model comprises a step of calculating thermal collision speeds representative of solvent bath thermal kinetics. For example, the thermal collision speeds may be calculated using random speeds selected from a normal distribution centered about zero and having a standard deviation σ equal to k_{B}T/m_{b}.

In another general embodiment, the invention includes a computer-implemented method of determining a directional solvent-accessible surface of an atom having a surface and neighboring atoms. The method includes, in any computationally-feasible order, the following steps: (i) locating a point on or near the surface of the atom, (ii) defining a surface normal vector at the point, and (iii) assessing whether the point is inside of any of the neighboring atoms, wherein a point not inside any neighboring atoms defines a collision point, and a surface normal vector at the collision point determines a directional solvent-accessible surface. One computationally-feasible order is as described above. Non-limiting examples of computationally-feasible orders include: (i), (iii), (ii); (ii), (i), (iii), and (ii), (iii), (i). In one embodiment, useful for determining a plurality of directional solvent-accessible surfaces of the atom, the method further includes repeating steps (i) through (iii) (in any computationally-feasible order) one or more times, each time for a different point on or near the surface of the atom. In a related embodiment, useful for determining collision points and directional solvent-accessible surfaces of a molecule comprising a plurality of the atoms, the method further includes repeating steps (i) through (iii) (in any computationally-feasible order) one or more times for each atom of the plurality of atoms. In another embodiment, useful for simulating kinetic behavior of the molecule in a solvent, the method further includes using the directional solvent-accessible surfaces in a corrected kinetic model to simulate the kinetic behavior of the molecule in the solvent. In one embodiment, each of the collision points is used as a location at which a net collision speed in the corrected kinetic model is determined.

In still another general embodiment, the invention includes a method for simulating kinetic behavior of a solute molecule in a solvent, The method includes, in any computationally-feasible order, the following steps: (i) providing a set of surface normal vectors representing directional solvent-accessible surfaces of the solute molecule; (ii) computing a dot product of vectors in the set with corresponding solute velocity vectors; (iii) defining a distribution of speeds representing kinetic effects of solvent particles, and (iv) using the dot product and the distribution to calculate kinetic forces on the solute molecule, the kinetic forces representing kinetic effects of the solvent on the solute molecule. In one embodiment, the speeds are selected from a normal distribution centered about zero and having a standard deviation σ equal to k_{B}T/m_{b}.

In any of the above embodiments, the simulating may include simulating kinetic behavior of two or more solute molecules simultaneously. Further, the solvent may be selected, e.g., from the group consisting of an aqueous solvent and an organic solvent. Other examples of solvent include a structured solvent, such as a lipid bilayer, a uniform solvent, and a non-uniform solvent. Furthermore, in any of the above embodiments, the solute molecule may be, for example, a polymer, such as a polypeptide, a polynucleotide, polysaccharide, etc., or a small molecule, such as a small organic molecule, e.g., drug, ligand, etc.

In yet another general embodiment, the invention includes a method of estimating a solvent accessible surface area of a solute molecule comprising a plurality of atoms, each atom comprising a surface. The method includes the following steps (in any computationally reasonable order): (i) for each of the plurality of atoms, locating one or more points on the surface of the atom, (ii) for each of the plurality of atoms, defining n geometrical objects, each object having a surface area, tangent to and on or near the surface of the atom and centered about one of the points, and (iii) calculating what portion of each object is not inside the surface of any other atom to generate data. The data are then used to estimate the solvent accessible surface area of the molecule. In one embodiment, the method further includes generating surface normal vectors at each of the points, where the geometrical objects and surface normal vectors form a representation of a solvent-accessible surface of the solute molecule. In one embodiment, the geometrical objects are selected from the group consisting of caps and disks. In a related embodiment, the surface area of each of the caps or disks is 4πr²/n. In another related embodiment, the geometrical objects are disks, each disk having a disk surface area, and wherein the disks are positioned such that one half of the disk surface area is inside the atom and one half of the disk surface area is outside the atom.

The present invention also provides for a computer system and computer code. The computer system preferably includes at least one processor and an associated memory subsystem, where the memory subsystem holds computer code to instruct the at least one processor to carry our any of the methods described herein.

It will be appreciated by one of skill in the art that the embodiments summarized above may be used together in any suitable combination to generate additional embodiments not expressly recited above, and that such embodiments are considered to be part of the present invention.

### BRIEF DESCRIPTION OF THE DRAWINGS

FIG. 1A shows a representation in two dimensions of the solvent-accessible surface area (SASA) of an exemplary molecule.

FIG. 1B shows the effect of a force applied to the molecule of FIG. 1A by a directional collision from a solvent molecule.

FIG. 2 is a 2-dimensional view of a sphere representing an atom, showing different sphere boundary representations used in estimating the SASA of the atom.

FIG. 3 is a 2-dimensional representation of atoms of a molecule.

FIG. 4 is a 2-dimensional view of the solvent accessible surface of a molecule, showing a directional solvent-accessible surface when the molecule is translating relative to the solvent.

FIG. 5A is a 2-dimensional representation of a solute molecule showing surface-normal vectors. FIG. 5B is a 2-dimensional representation of the solute molecule in FIG. 5A showing the dot product of surface-normal vectors and the velocity of the molecule relative to the solvent. FIG. 5C is a 2-dimensional representation of the solute molecule in FIG. 5A consisting of a body ^{l}B with 23 spherical patches ^{l}pⱼ and corresponding surface normal vectors.

FIG. 6A is a process flowchart showing the steps taken in executing a corrected kinetic model according to one embodiment of the present invention. FIG. 6B is a process flowchart showing how a corrected kinetic model according to one embodiment of the present invention may be applied in the context of a molecular dynamics simulation.

FIG. 7 is diagram of a computer system useful for executing methods of the present invention.

FIGS. 8A-8E show molecules simulated as described in Example 1 at five time points (FIG. 8A: time zero; FIG. 8B: 2.5 ps; FIG. 8C: 5 ps; FIG. 8D: 10 ps; and FIG. 8E: 20 ps).

### DETAILED DESCRIPTION

I. Definitions

Unless specified otherwise, an “atom” is defined herein as a representation of (i) an elemental atom, or (ii) a “unified” atom, in the modeling method or algorithm under consideration. Such a representation is often, but not always, a sphere. A unified atom refers to a small group of atoms that, for the purposes of molecular modeling & simulation, are treated as a single atomic unit. For example, although a water molecule comprises an oxygen atom and two hydrogen atoms, represented in a space-filling model as a larger sphere with two smaller spheres embedded in it at a characteristic angle relative to one another, the water molecule is often represented in molecular models, simulations & related algorithms as a “unified” spherical atom having a van der Waals radius of 1.4 Angstroms.

A “body”, in the context of a component of a molecule, is defined as a unit of the molecule which is treated as a single mass or geometric structure for purposes of modeling the molecule. Accordingly, a body can be an individual atom of the molecule, a collection of atoms, or other abstract system of masses. A “rigid body” is a body that is modeled as rigid (i.e., it does not deform in response to forces exerted on it).

A “computationally-feasible order” refers to any order in which a particular sequence of tasks can be executed without altering the ultimate result. This concept is invoked, because in some methods, the order of certain steps is not important, so long as the steps are executed and the result is the same as if they were executed in the order originally presented.

A “corrected kinetic model” is any implicit solvent kinetic model of solute-solvent interactions that accounts for the directionality or orientation of the solute surface at different locations on the solute surface.

An “explicit solvent model” is a model of the effects of solvent in a molecular dynamics simulation that simulates the dynamics of each molecule of the solvent in the vicinity of a solute molecule under study, and does not simulate the effects of the solvent on the solute via bulk solvent properties (with the exception of enforcement of boundary conditions).

A “geometrical object” is any two- or three-dimensional object that can be placed adjacent or mapped onto a sphere. Exemplary geometrical objects are “caps” and “disks”.

An “implicit solvent model” is any model of the effects of solvent in a molecular dynamics simulation that is not an explicit solvent model. Implicit solvent models use at least some bulk solvent properties to represent the effect of the solvent on the solute, but may contain several individual “local” solvent molecules (e.g., in the vicinity of a ligand-binding site on the solute molecule) which are simulated as they would be in an explicit solvent model.

A “non-uniform solvent” is a solvent comprising two or more types of solvent, e.g., an aqueous solvent and an organic solvent. An exemplary non-uniform solvent is a lipid bilayer membrane surrounded by aqueous solvent.

A “polymer” is any organic polymer molecule. Examples of polymers include biopolymers (e.g., polypeptides, polynucleotides and polysaccharides); polymer plastics (e.g., polyethylene, polypropylene, polystyrene, etc.); polymer fluids (e.g., polyethylene glycol, etc.), and the like.

A “representation of a solvent-accessible surface” refers to a set of data which represents the surface of a selected molecule. The data set may include the solvent-accessible surface area (SASA), the spatial location of selected points on the surface, and/or information on the geometric orientation of the surface relative to the molecule. An exemplary representation of a solvent accessible surface is a set of surface normal vectors arranged on atoms of the molecule that are accessible to the solvent.

A “small molecule” refers to any molecule that is not a polypeptides, polynucleotides or polysaccharide, and that has a molecular weight less than about 5 kDa. A small molecule is generally not a polymer, and can be a small organic molecule, a ligand, a lead compound, a drug, a new chemical entity (NCE), etc.

A “solvent” refers to any medium which can contain a solute molecule. Non-limiting examples of a solvent include water & other aqueous solvents, as well as organic solvents (e.g., DMSO, lipids, alcohol, etc.). The solvent may be uniform or non-uniform, and may be in solid, liquid or gaseous form.

A “station point” is a unique location on the surface of, or within a body, that is stationary with respect to that surface or body. A “center point” is a station point that is located at a body's center of mass. Station points are used in defining specific locations on a body which can have defined positions, velocities, accelerations, geometric attributes, charges, etc., and which can be acted on by outside forces to change the body's static or dynamic properties.

II. OverView

Work performed in support of the present invention indicates that directional effects are important in accurately modeling the kinetic effects of a solvent on a solute using an implicit solvent model. These effects are modeled as energy transfer (representing collisions of the solvent molecules with the solute) at the solute's solvent accessible surface area (“SASA”). Accordingly, methods described herein have been developed to make more efficient computations and estimates of SASA, as well as providing information on the orientation of the solvent accessible surface at any selected point. Further, methods have been developed to take advantage of this directional SASA information in designing more accurate molecular dynamics models which employ implicit solvent models.

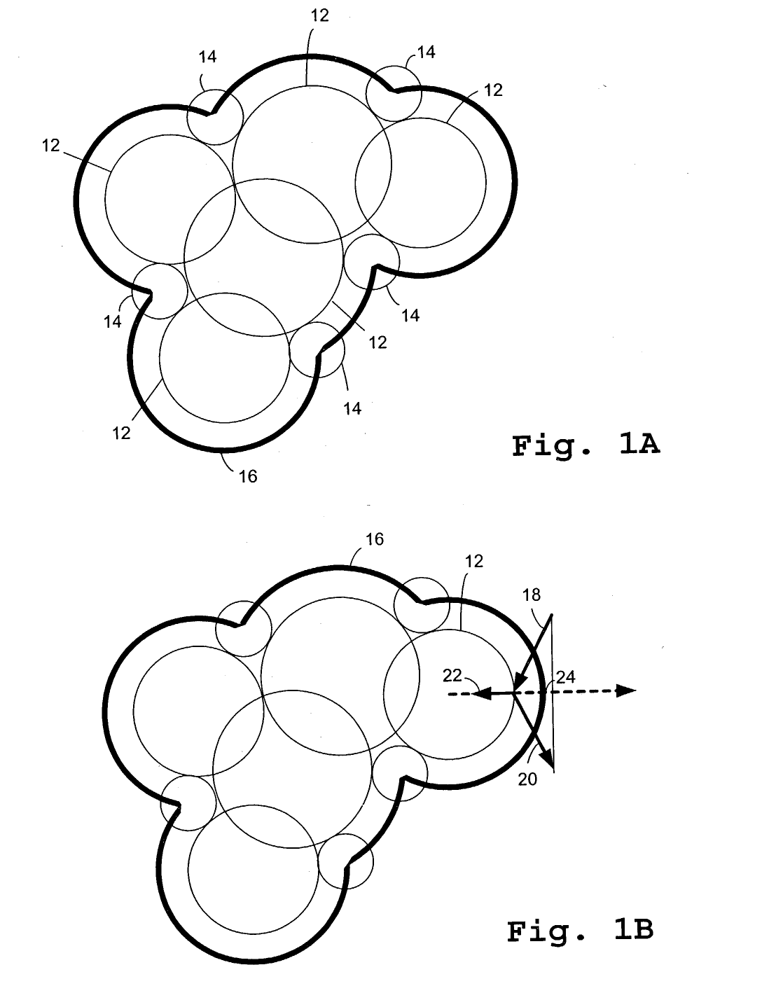

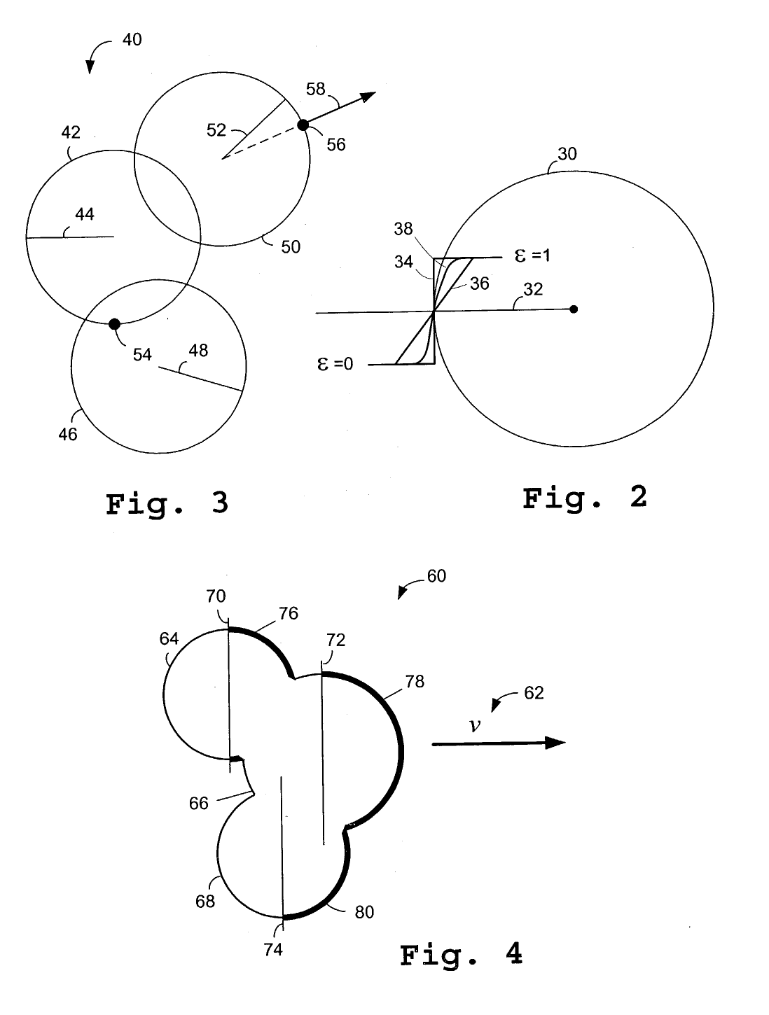

In one embodiment, the model is constructed such that interactions between solvent and solute (modeled as frictionless impacts) can deliver forces only along the local solvent accessible surface normal. This concept is illustrated with reference to FIG. 1B. A solvent molecule approaching the solvent accessible surface 16 of atom 12 along vector 18 would strike the surface and rebound along vector 20, imparting a force 22 directed opposite the surface normal 24. As will be more fully described below, one can construct kinetic models that take into account the velocity of the solute surface 12 relative to the solvent, the directionality or orientation of the solute surface, and effects of the solvent (expressed as collisions at the solute's solvent molecular surface), to achieve a more accurate molecular dynamics simulation of a selected solute molecule.

III. Solvent Accessible Surface Area

A. Voxel Grids

Computations of SASA can be facilitated by determining which atom-representing spheres are intersecting with one another. The calculation may be performed by assessing, for each pair of atoms in the molecule, whether they intersect. However, such a pair-wise comparison is proportional to the square of the number of atoms, and thus becomes computationally expensive in the case of molecules with large numbers of atoms. A more efficient method employs a “voxel grid” (see, e.g., Wyvill, B., “3-D Grid Hashing Function” In Graphics Gems, Glassner, A., Ed., Academic Press Professional, Boston, 1990). A “voxel”, shorthand for “volume element”, is a three-dimensional (“3-D”) analogy of a pixel or two-dimensional picture element. Accordingly, a voxel can be thought of as a cube and voxel grid as a grid of cubes. The voxel grid is preferably defined to have a size sufficient to contain the entire molecule, with the dimensions of the voxels selected such that the sides of the voxels are slightly longer than the diameter of the largest atom being represented. This results in every atom being contained within a single voxel or small group (up to eight) voxels. A dataset is then constructed defining, for each atom, the voxels that contain at least a part of such atom. To determine which atoms intersect, a pair wise comparison is performed only between atoms that are, at least in part, contained in the same voxel. Using the voxel grid approach is more efficient than a pair-wise comparison, because the number of comparisons that need to be made is roughly proportional to the number of atoms, as opposed to the number of atoms squared.

Station Points & Surface Normals Used in Approximating SASA

Methods described herein for estimating SASA typically involve, as a first step, distributing a set of “station points” on the surface of the body whose area is to be computed. The station points may be distributed uniformly, near-uniformly or randomly over the surface of each body. Any of a number of methods capable of generating randomly distributed points on the surface of a body may be employed. For example, one method that may be used to randomly distribute a set of points on the surface of a sphere is as follows. A line is defined as passing through the sphere and intersecting the center (i.e., a line corresponding to the sphere's diameter). A random number is generated to specify a random location on the portion of the line that lies within the sphere. A vector is then defined, which originates on the line at the selected location or point, and is oriented perpendicularly to the line. A second random number is then generated to specify the rotational angle of the vector about the line. The intersection of this vector with the surface of the sphere defines a random point on the surface of the sphere.

According to one aspect of the invention, a surface normal (defined as a unit vector pointing toward the station point from the center of the atom on which that station lies) may be associated with each station point. Like the point locations, the surface normal orientations are fixed with respect to the atom or body with which they are associated.

Optimizing Point Distribution

After a set of station points has been defined or placed on the sphere surface, the location of each point may be optionally adjusted or “optimized” such that the points are regularly spaced on the surface of the body under consideration. Any of a number of suitable optimization methods may be used for this. For example, one can exploit spatial coherence in the station points, as described by Frank Eisenhaber, et al. Journal of Computational Chemistry. 16:273-284. A sphere which contains a particular station point is more likely to contain neighboring station points than a randomly chosen intersecting sphere. To take advantage of this, the station points are sorted in such a way that each station point is followed by some near it. Specifically, a Voronoi diagram is computed and after a given station point is inserted on the list, each of its uninserted Voronoi neighbors is inserted. Other optimization methods are known in the art.

Estimating SASA Using Geometrical Objects

Studies performed in support of the present invention indicate that geometrical objects other than points, are advantageous in performing a SASA calculation. These other objects include disks (circular or polygon-shaped) and “caps”. A “cap” is a semi-spherical cap, or circular portion of the surface of a sphere (e.g., a tangent disk mapped onto the surface of the sphere), and is defined by the region of the sphere on one side of a plane that intersects the sphere. It is implemented as described below for the disk method. Other shapes can be used as well, by applying the principles detailed herein.

In estimating SASA, the surface of the spheres representing atoms are populated by a set of such objects, and the total computed area is calculated as the sum of areas of these objects or their fraction that are not inside any other sphere. For example, each station point may be used to define the center of a disk or a spherical cap at the sphere's surface. The area of each object (e.g., disk or cap) is preferably selected such that given a set of n station points, each object has an area of 4πr²/n, where r is the radius of the atom under consideration. In other words, each such approximating shape carries a weight of 4πr²/n. The disk method works by placing a circular disk perpendicular to the surface normal (i.e., tangent to the surface of the atom), and has two free parameters: the distance that the center of disk is displaced from the center of the sphere (the “offset”) and the radius of the disk. In one embodiment, the parameters are selected such that the area of the portion of each disk that is inside the sphere is equal to the portion of the area of the disk that is outside of the sphere. This approach provides a simple method for selecting the parameters, but results in a slight underestimation of the correct area in certain applications (discussed more fully below), since there is more volume just outside a sphere then just inside of it. Applications using the caps method have only one free parameter—:the radius of the cap.

The SASA calculation is performed by evaluating, for each object (e.g., disk), whether it is inside another atom. If no portion of the object is inside another atom, the entire area of the object (e.g., disk) is summed and included in the SASA calculation; if the entire object is contained inside another atom, the objects area is not considered for the SASA calculation; and if a portion of the object is inside another atom, then only that portion which is outside the other atom is used in calculating the SASA.

Weighing Methods at Neighboring Atom Boundaries

In one embodiment of the invention, particular techniques, termed “weighed point”, “weighed disk” or “weighed cap” methods, are employed when a station point is close to being inside of another atom or sphere. In these situations, the boundary between “inside an atom” and “outside an atom” may be defined as a graded function, rather than a discontinuous step. A weighing function or factor ε is defined, which specifies to what extent a point is inside another sphere (atom or body). This is illustrated with reference to FIG. 2. Locations where ε=0 are defined as being completely outside of sphere 30, whereas locations where ε=1 are defined as being completely inside of the sphere. In a “sharp boundary” model, as one moves along line 32 from outside to inside of sphere 30, ε is a step function 34 going from zero to one at the sphere boundary. However, in a “fuzzy boundary” model (a model suitable for use with the weighted point or weighted disk method), ε changes more continuously as a function (e.g., a ramp function 36 or a smooth (e.g., “s”-shaped) function 38) as one crosses the sphere boundary. Thus, if a point is close to being inside or outside another sphere, it is weighted by the factor ε, corresponding to the point's or disk's distance inside or outside the sphere. The final weight is the product of all the weights and this weight gives the fraction of the area contribution for this point. A linear weighting (corresponding, e.g., to ramp function 36 for ε) gives a continuous area as the spheres are translated continuously. Non-linear weighting (corresponding to a smooth, e.g., s-shaped function 38 for ε) can also provide continuous derivatives.

B. Generating Random Solvent Accessible Points

In some cases, e.g., modeling thermal interactions between solute & solvent, it may be desirable to have the ability of generating random locations on the solute where a solvent molecule (e.g., water), can collide with the solute. One suitable method of computing such points is to calculate which regions of the solute are accessible to the solvent (e.g., calculate the solvent accessible surface as described above), and then pick random points on the surface (or portions of the surface) via a suitable parameterization of the solvent-accessible surface area. However, this approach can be computationally expensive, because it requires a recalculation of the entire solvent accessible surface for each time point at which it is desired to simulate a thermal interaction.

An alternative algorithm, which can provide the same statistical behavior at a much lower computational cost, was therefore developed. According to this method, each atom is sequentially chosen from the molecule being modeled, and a point or location on or near the atom's surface, extended by a distance equal to the radius of a solvent molecule, is randomly selected, e.g., using the approach described above. The selected point is then tested to determine if it is inside any other atom's SAS, using, e.g., information obtained from a voxel diagram. If the point is not inside any other atom's SAS, then that location is used, optionally with a weighing function as described above. The process is repeated up to a desired number of samples per atom.

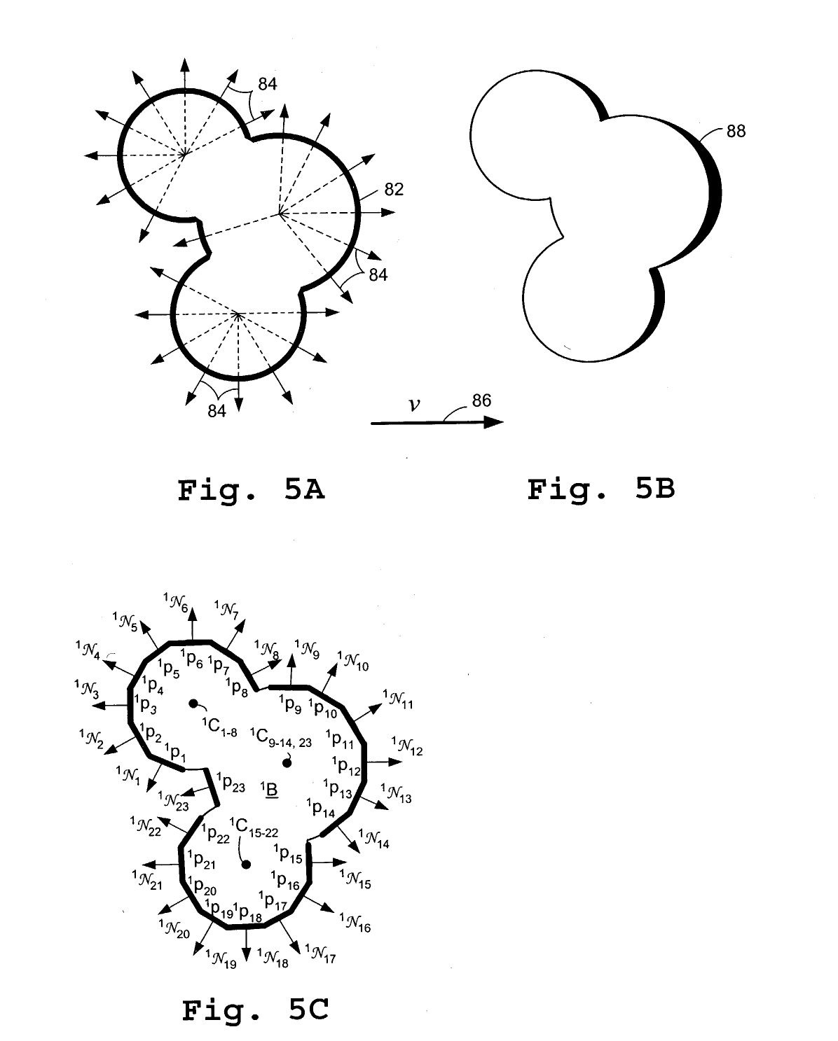

The method is illustrated with reference to FIG. 3. Molecule 40 consists of 3 atoms, represented by solvent-accessible surface spheres 42, 46 and 50. The spheres have radii 44, 48 and 52, respectively. A point 54 is randomly generated on sphere 46, and is tested to determine if it resides within any neighboring spheres, e.g., by asking if it is within the radius of any neighboring spheres. A quick calculation determines that it is not within radius 52 of sphere 50, but is within the radius 48 of sphere 46. The process is therefore repeated, and point 56 is generated on sphere 50. A quick calculation determines that point 56 is not within either radius 44 or radius 48, and the point is noted as having a location on the surface of molecule 40. This point may be used to define a surface normal vector 58 perpendicular to the surface of the sphere at point 56.

This approach may be used in a method (e.g., a computer-implemented method) for determining “collision points” or directional solvent-accessible surfaces of an atom. By way of example with continued reference to FIG. 3, point 56 is located on or near the surface of the atom, and surface normal vector 58 is defined at point 56. An assessment is made as to whether point 56 is inside of any of the neighboring atoms (i.e., whether it is inside atoms 42 or 46). Since point 56 is not inside any neighboring atoms, it defines a “collision point”, and surface normal vector 58 at the collision point determines a directional solvent-accessible surface. Although many points may need to be generated and tested, it is an extremely simple and computationally-efficient operation, since it is not necessary to calculate the solvent-accessible surface in order to generate the points.

C. Directional SAS

According to the present invention, it may be desirable to calculate the orientation or directionality of the SAS with respect to a selected coordinate system. This is applicable both in cases where solute atoms are translating relative to the solvent, and for “thermal bath” effects. Note that even in situations where there is no net flow of solute, individual solute atoms may, as a result of thermal vibrations and internal motions, achieve a net translation relative to the solvent which surrounds them. For these and other situations, it may be advantageous to calculate which part of the SAS is on the leading edge or portion relative to the direction of motion. There are several methods for obtaining such a directional SAS.

For example, as illustrated in FIG. 4, a surface normal vector can be generated for each point (or a subset of points) on the solvent-accessible surface of a solute molecule 60. For a given direction v, shown at 62, a “simple” directional SAS can be defined as the total accessible area of all points with surface normal n, such that n·v<0. This is computed by clipping each of exposed spheres 64, 66 and 68 with a half-space 70, 72 and 74, respectively. Each half space is perpendicular to v, and passes through the center of its corresponding sphere. The portion of the SAS that is considered for translation-dependent interactions with the solvent is indicated by the heavy lines 76, 78 and 80.

The geometrical objects (e.g., disks & caps) and random-points methods described above may also be used to calculate a directional SAS, i.e., to provide a directional solvent-accessible surface. For example, in the case of disks, this is accomplished by computing the dot product of the surface normal at each disk with direction v. Mathematically, this can be expressed as follows:

Non-directional SASA:

$$A = {\sum }_{exposed\_disk \_i} ( ratio\_of \_exposed \_disk ) \times ( disk\_area )$$

Directional SASA:

$$A = {\sum }_{exposed\_disk \_i} ( ratio\_of \_exposed \_disk ) \times ( {N}_{i} \cdot v ) \times ( disk\_area )$$

where Nᵢ is the disk normal, v is the velocity of its center point and the summation is limited to cases where Nᵢ·v<0.

IV. Corrected Kinetic Model

A corrected kinetic model is any implicit solvent kinetic model of solute-solvent interactions that accounts for the directionality or orientation of the solute surface at different locations on the solute surface. An exemplary corrected kinetic model is described below.

A. Surface Normal and Velocity Vectors

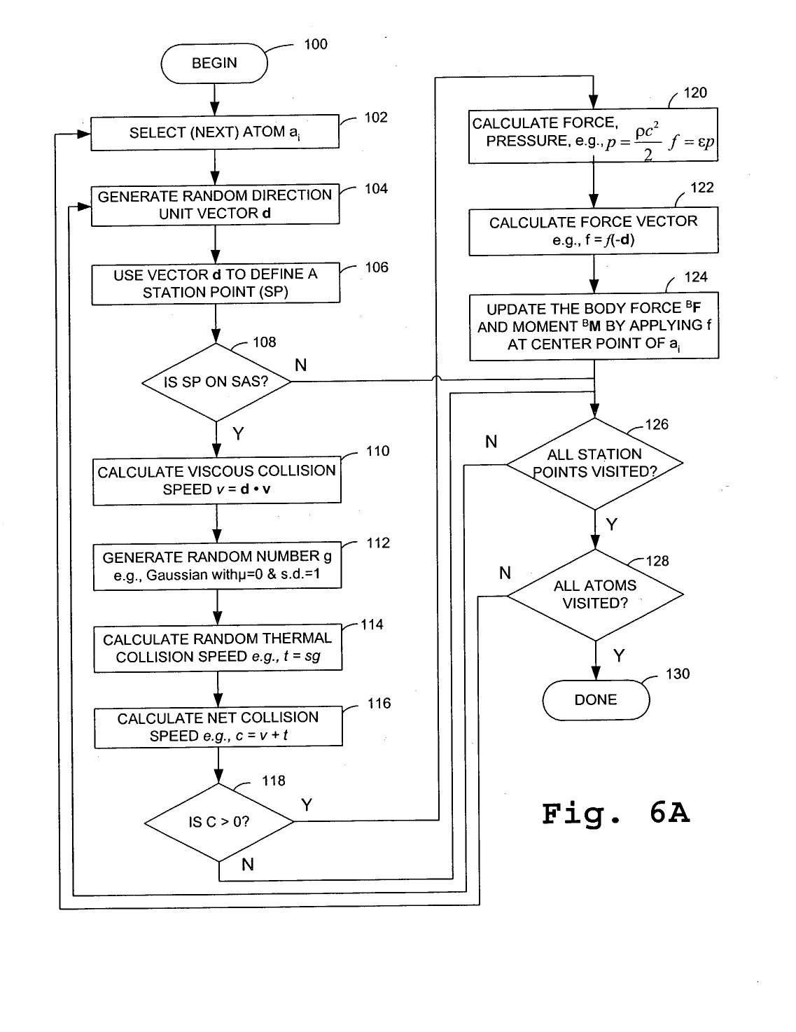

In one aspect, the present invention provides methods of modeling non-conservative kinetic interactions between a solute and solvent using implicit solvent models. The methods make use of one or more representations of the solvent-accessible surface of the solute molecule that include information on the geometric orientation of the solute surface. The directional information may be obtained, for example, as detailed above, by defining surface normal vectors on the solvent accessible surface (“SAS”). A simple molecule illustrating the basic concept of surface normal vectors on the solvent-accessible surface is shown in FIG. 5A. The heavy outline 82 corresponds to the molecule's solvent-accessible surface. Surface normal vectors 84 are shown situated on and perpendicular to the solvent accessible surface.

Methods of the invention employ a corrected kinetic model, which takes the orientation of the solvent accessible surface into account, in the context of a molecular dynamics simulation to provide more realistic or accurate results. Characteristics of this model may be appreciated with reference to FIGS. 5A and 5B, which show a body translating relative to the solvent with a velocity v, designated by velocity vector 86. The dot product of velocity vector 86 and the surface normal vectors 84 is calculated at each selected region (point, patch, etc.) on the solvent-accessible surface, generating a scalar value corresponding to the “viscous collision speed” at that point or patch relative to the solvent. The magnitude of this scalar value (in cases where it is greater than zero) is illustrated as a line of varying thickness 88 in FIG. 5B. As can be appreciated, the magnitude is greatest at points on the surface that are perpendicular to and moving in the direction of velocity vector 86.

A relevant framework for a corrected kinetic model according to the invention can be expressed in general terms with reference to a solute or molecule consisting of N bodies ^{b}B, where 1≦b ≦N. A set of ^{b}n regions (e.g., spherical patches) ^{b}pⱼ of area ^{b}aⱼ (1≦j ≦^{b}n) is defined. Each patch ^{bp}ⱼ is on a sphere representing an atom whose center point ^{b}Cⱼ is a fixed station on ^{b}B. It is possible to have more than one patch on the same sphere, so some of the ^{b}Cⱼ may be identical for different j. Vector-valued functions ^{b}Nⱼ and ^{b}Vⱼ are defined ranging over points of the patch ^{b}pⱼ and giving the unit surface normal and inertial velocity, respectively, for each point.

Although this framework will typically be applied to molecular dynamics simulations in three dimensions, it may be helpful to visualize the framework in two dimensions. FIG. 5C therefore illustrates a simplified expression of the above framework in two dimensions for a body ¹B, consisting of 3 atoms modeled as overlapping spheres. Body ¹B is shown with a set of regions or patches ¹p₁₋₂₃, representing an aspect of the solvent-accessible surface area. Surface normal vectors ¹N₁₋₂₃, define the normal for each of patches ¹P₋₂₃, and are used to provide the orientation or directionality of the solvent-accessible surface at representative points on body ¹B.

B. Viscous Collision Speed

The viscous collision speed is a scalar function ^{b}vⱼ whose value at each location or point on a patch is given by the dot product of the surface normal vector ^{b}Nⱼ and the velocity vector ^{b}Vⱼ evaluated at that point, such that ^{b}vⱼ=^{b}Nⱼ·^{b}Vⱼ. Accordingly, the viscous collision speed ^{b}vⱼ gives the rate at which any point on patch or region ^{b}pⱼ is penetrating into (in cases where ^{b}vⱼ>0), or retreating from (in cases where ^{b}vⱼ<0) the stationary bulk solvent.

C. Solvent Bath Thermal Kinetics

The solvent's (or bath) thermal kinetics can be described at any point in space by three scalar quantities: solvent molecular mass m_{b}, the local density ρ (mass per unit volume) at that point, and the temperature. In a uniform solvent, m_{b} & ρ are of course a constant. However, in a system comprising a non-uniform solvent, such as a protein in a lipid bilayer membrane surrounded by aqueous solution, m_{b} & ρ may have different values at different spatial locations. Accordingly, when modeling, e.g., a membrane protein, the portions of the protein that are in the bilayer membrane are simulated using m_{b} & ρ appropriate for the lipid bilayer, whereas portions exposed to aqueous solution are modeled using m_{b} & ρ appropriate for the aqueous solution.

Given a mass m_{b} and a temperature T, it is possible to generate statistically-correct sample velocities at selected points in space, as follows: for a selected point in space, a random speed S (a scalar) is generated from a normal distribution centered about zero and having a standard deviation σ, where σ is defined as k_{B}T/m_{b}. Here, k_{B} is Boltzmann's constant (1.4×10⁻²³ J/K), m_{b} is the mass of a solvent (bath) molecule at that point in space (in the case of water, m_{b}=18 g/mole or 2.99×10⁻²³ g), and T is the temperature in Kelvin (approximately 300K for room temperature).

D. Thermal Collision Speed

The thermal collision speed is a scalar function calculated by taking the negative of the normal vector N multiplied by the solvent speed S at a selected point on the solvent-accessible surface of the solute molecule. Its value can be expressed, in terms of previously-defined variables, as ^{b}tⱼ=−^{b}Nⱼ×S, where ^{b}tⱼ can be evaluated at any point on patch ^{b}pⱼ by evaluating ^{b}Nⱼ and generating a speed S for that point. ^{b}tⱼ provides the rate that local thermal motion is impinging on (^{b}tⱼ>0), or retreating from (^{b}tⱼ<0) the solute patch ^{b}pⱼ at any point of that patch.

E. Net Collision Speed and Energy Per Unit Volume

The net collision speed is defined as ^{b}sⱼ=max (^{b}vⱼ+^{b}tⱼ, 0), and represents the net speed with which the solute and a virtual solvent “particle” collide. Accordingly, ^{b}sⱼ is always greater than or equal to zero. The energy per volume, or pressure, applied by the solvent to each point on ^{b}pⱼ. is also a scalar function, expressed as ^{b}eⱼ=ρ(^{b}sⱼ) ²/2 (with ρ evaluated at the appropriate point).

F. Total Randomized Force on Patch

The total randomized force ^{b}Rⱼ on patch ^{b}pⱼ can be expressed as ^{b}Rⱼ=∫∫^{b}eⱼ^{b}Nⱼd^{b}aⱼ. Note that this is a surface integral across the patch; b and j remain fixed. ^{b}Rⱼ can then be applied at the station corresponding to the center ^{b}Cⱼ of the sphere on which ^{b}pⱼ lies. Thus patch ^{b}pⱼ's contribution to the force ^{b}F and moment ^{b}M on body ^{b}B are ^{b}Rⱼ, and ^{b}Cⱼ×^{b}Rⱼ, respectively.

G. Other Considerations

It will be appreciated that the integrals may be solved by discretizing each patch ^{b}pⱼ into one or more sub-patches over which the local solvent properties (density, local velocity) can be considered constant. Depending on the level of geometric precision desired, the normals and velocities at points on the patch may also be discretized or otherwise approximated, either systematically or by generating random surface points. Furthermore, these terms may be computed as impulses (force times time) and applied periodically rather than continuously.

H. Exemplary Embodiment

An exemplary embodiment of the general methods and approaches detailed in Sections IV A-G above is described with reference to the process flowchart in FIG. 6A. This process can be viewed as describing a “subroutine” for calculating directional solvent kinetic forces F_{K} and moments M_{K}. This subroutine can be called or incorporated in the general molecular dynamics simulation detailed below in Section V.

The following is a list of definitions for variables, functions, and other parameters used in the process: (i) m is the mass of a solvent molecule (e.g., a water molecule of 18 Da); (ii) s=√(k_{B}T/m) Å/ps is the average speed of a solvent molecule in each degree of freedom; (iii) ρ is the density of the solvent at the selected modeling temperature in Da/Å³ (e.g., water at room temperature); and (iv) n is the chosen number of sample points per atom. For each atom aᵢ in any of the solute molecules, (a) r is the van der Waals radius of atom aᵢ in Å; (b) ε=4πr²/n and equals the area fraction represented by each sample point; (c) v=the inertial (ground frame relative) velocity of atom aᵢ's center point; and (d) B is a rigid body to which atom aᵢ is affixed.

The process starts at step 100. An atom aᵢ is selected at step 102. At step 104, a uniformly-distributed random direction is then generated as unit vector d. The vector is placed such that it originates at the center of atom aᵢ, thereby defining a station point on the surface of the atom at step 106. At step 108, the station point is tested to determine if it is on the solvent accessible surface of atom aᵢ. If not, the process jumps to step 126, discussed below. Otherwise, the process continues to step 110, where the viscous collision speed v=d·v is calculated as dot product of unit vector d and atom aᵢ's inertial velocity v. A random number g is then generated at step 112 using a Gaussian distribution having a mean of zero and a standard deviation of one. The thermal collision speed t is calculated at step 114 by multiplying the average speed of a solvent molecule s by the random number g. Then, at step 116, the net collision speed c is determined by summing the viscous collision speed v with the thermal collision speed t. If the net collision speed c is less than or equal to zero at step 118, the sample is ignored (no collision takes place), and process jumps to step 126, discussed below. If the net collision speed c is greater than zero, we continue to step 120, to calculate the pressure (p=ρc²/2, in force units/unit area), and force magnitude f=εp. The force vector f=ƒ(−d) is calculated at step 122. Force vector f is then applied at atom aᵢ's center point to update the body force ^{B}F and moment ^{B}M at step 124.

At step 126, a decision is made whether the requisite number of station points have been visited on atom aᵢ, i.e., if enough samples had been obtained from that atom. If not, the process is repeated by going back to step 104 and generating another random direction unit vector d. Note that step 126 is also reached (i) if a station point defined by unit vector d is not on the solvent-accessible surface at step 108, or (ii) if net collision speed c is negative at step 118. The number of samples per atom is generally between about 1 and 100, preferably between about 5 and 50, and more preferably between about 5 and 20, e.g., 10. The number is selected to provide a sufficiently-realistic simulation of the non-conservative kinetic effects.

If enough samples had been obtained from atom aᵢ, the next question, posed at step 128, is whether all atoms in the molecule had been visited. If one has knowledge that a certain atom is on the interior of the molecule and not exposed to solvent, one can of course neglect to visit that atom without affecting the accuracy of the model. However, if one is uncertain as to whether a particular atom is exposed to solvent, the atom should be visited by returning back to step 102 and selecting that atom. Once all relevant atoms have been visited, all forces and moments F_{K} and M_{K} due to solvent kinetics have been calculated, and the process is completed at step 130.

A corrected kinetic model formulated according to the above-described framework is described in the context of a molecular dynamics simulation below.

V. Molecular Dynamics Simulation Using a Corrected Kinetic Model

In one aspect, the present invention provides improved methods of conducting molecular dynamics simulations of one or more selected “solute” molecules suspended in a solvent, e.g., an aqueous solvent. General methods for conducting molecular dynamics simulations are well known (see, e.g., T. Schlick, Molecular Modeling and Simulation—an Interdisciplinary Guide, New York, 2002, Springer Verlag; A. Leach, Molecular Modeling—Principles and Applications (2^{nd} ed.), Dorchester, England, 2001, Prentice Hall/Dorset Press; and Rapaport, D.C., The Art of Molecular Dynamics Simulation, Cambridge, England, 1995, Cambridge University Press). In essence, a molecular dynamics model simulates the movement of real molecules by repeatedly moving the atoms of the system under the influence of forces (detailed below). After each movement of the modeled molecule(s) to a new conformation, the forces are redetermined and the bodies or atoms are again moved, but this time under the influence of the new forces. These methods are typically implemented via a computer, such that the relevant algorithms are coded in one or more computer software programs and executed on a computer or a group of computers.

In the methods of this invention, a representation of a molecular system is initially prepared in a computer usable form. The molecules which form the molecular system being modeled are typically partitioned into a set or sets of bodies, which may be either individual atoms, or collections of atoms connected to one another, or more abstract mass and/or geometry-carrying units. In cases where the bodies are modeled as “rigid” bodies, the relative locations of individual atoms comprising the rigid body can be considered invariant during the simulation.

The bodies are defined with respect to a selected set of generalized coordinates which collectively express the locations and orientations of these bodies, and provide a reference frame for calculating kinetic properties, such as momentum, velocity and acceleration. The coordinates can be the Cartesian x, y, z locations and velocities of the bodies in space. Alternatively, the system can be modeled with internal, e.g., torsion angle, coordinates, where the relative displacement between the bodies (but not their absolute position) is tracked, along with the (absolute) x, y, z spatial location of one of the bodies, designated the base body. Other representations are also possible, e.g., the Cartesian rigid body approach described in Turner, et al., U.S. Pat. No. 5,424,963.

The bodies are held in relationship to one another by covalent bonds, which constrain the conformation space that can be adopted by the molecule, but also allow for certain movements and rotations of the bodies relative to one another. The covalent bonds, as well as non-covalent interactions (including hydrogen bonds, van der Waals interactions and electrostatic interactions) are expressed as energy fields, which result in forces on the individual bodies making up the molecule being modeled. These forces make up the “intra-solute” forces at work “within” a solute molecule, and the inter-solute forces between solute molecules. It should be noted that the presence of implicit solvent around the solute molecules may influence the parameters which define the intra-solute and inter-solute forces. In addition to the above-described intra- and inter-solute forces, the direct effects of implicit solvent on the solute may be expressed as impulse functions, forces, or as energy functions which result in forces.

The forces are used in differential equations which describe the kinetics of the molecule or system being modeled. For multibody systems such as molecular dynamics simulations, these equations are solved using numerical integration methods. Any of a number of known integrators may be used—each approach has its advantages and disadvantages. See, for example, Hairer, et al., Solving Ordinary Differential Equations I, 2^{nd} ed, Springer Verlag, Heidelberg, (1993); Hairer and Wanner, Solving Ordinary Differential Equations II, Springer Verlag, Heidelberg (1991); PCT publication numbers WO02/39087 (Sherman & Rosenthal; Method for Large Timesteps in Molecular Modeling); WO02/36744 (Rosenthal; Method for Residual Form in Molecular Modeling); and WO02/061662 (Rosenthal; Method for Analytical Jacobian Computation in Molecular Modeling)

FIG. 6B is a flowchart summarizing an incorporation of a corrected kinetic model into a general molecular modeling method framework. A computer dynamics simulation is set up and initiated using known approaches, e.g., as described above, and a computer-based simulation is initiated at step 130. At some point during each time step during the simulation, a decision is made at step 134 as to whether to invoke the corrected kinetic model calculation (the corrected kinetic model methods of the invention do not need to be applied at every time step during the simulation, in fact, the corrected kinetic model was invoked only ten times during the simulation described in Example 1, below). Examples of factors which can be used in determining whether to invoke the corrected kinetic model include asking if (i) a requisite amount of time has elapsed since the last application of the model, (ii) the temperature of the solute is outside of a specified range, and (iii) a requisite number of timesteps have been taken. For example, one may decide to invoke the model every 1-2 ps in a 10-20 ps simulation. A force or impulse may be applied as desired by the user of the method to adequately simulate the kinetic effects of the solvent. For example, an impulse may be applied at every time step, every other time step, or at a lower rate as necessary. An impulse may also be at selected time points (ranging between, e.g., every 100 fs to every 100 ps.)

If the kinetic effects are to be applied, a corrected kinetic model as described above is invoked at step 136 to calculate all forces and moments F_{K} and M_{K} due to solvent kinetics (an exemplary process for obtaining F_{K} and M_{K} is described above with reference to FIG. 6A, above). Body forces F and moments M are updated using F_{K} and M_{K} at step 138, and the process return to the general simulation protocol at step 140, at which point conservative forces F_{C} and moments M_{C} are generated. Note that if the corrected kinetic model was not invoked at a particular time step at decision step 134, the simulation would jump directly to step 140.

At step 142, body force F and moments M are updated using forces F_{C} and M_{C}, and system accelerations are calculated at step 144 using F and M. At step 146, the simulation then numerically integrates the resulting equations to advance time one step. A decision is made at step 148 as to whether enough time steps had been taken. If so, the process is completed at step 149. Otherwise, it returns to step 134 for at least one more cycle.

VI. Computer System

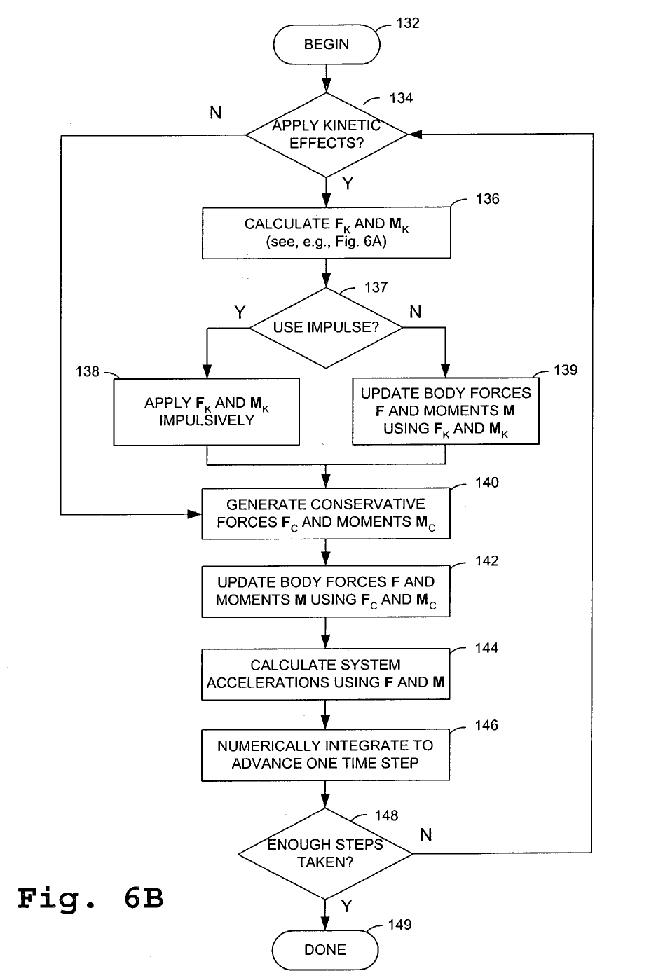

To carry out the calculations described above, a computer system may be used with at least one processor and associated memory subsystem for holding the computer code to instruct the processor to perform the operations described above. FIG. 7 illustrates the basic architecture of such a computer system having a processor 151, a memory subsystem 152, peripherals 153 such as input/output devices (keyboard, mouse, display, etc.), perhaps a co-processor 154 to aid in the computations, and network interface devices 155, all interconnected by a bus 150. The memory subsystem optimally includes, in increasing order of access latency, cache memory, main memory and permanent storage memory, such as hard disk drives. Given the amount of intensity of computation, it should be understood that the computer system could include multiple processors with multiple associated memory subsystems to perform the computations in parallel; or, rather than having the various computer elements connected by a bus in conventional computer architecture as illustrated by FIG. 7, the computer system might formed by multiple processors and multiple memory subsystems interconnected by a network.

VII. Industrial Applicability

This invention will allow for more accurate simulation of molecules in solvent while maintaining the computational efficiency of an implicit solvent model. This will provide benefits in applications of molecular mechanics including, but not limited to, biomolecular structure prediction such as protein, nucleic acid and smaller molecule structures, protein-ligand interaction calculations including structure and binding affinity, protein-protein interactions and in silico drug lead synthesis and activity determination.

The following example illustrates but in no way is intended to limit the present invention.

### EXAMPLE 1

### Effects of Solvent Viscosity on Translation of a Solute Molecule

Methods of the invention were used to compare the results of simulations conducted using traditional implicit solvent approaches of modeling solute-solvent interactions with implicit solvent approaches utilizing directional SASA information according to the methods of the present invention. The comparison was conducted by simulating two identical peptides with the two simulation approaches. The peptides each consisted of 20 glycine amino acids, with neutral end caps—an acetyl group at the N-terminus and N-methylamide at the C-terminus. The peptides were placed in an alpha helix conformation by setting each pair of backbone angles phi=−68.15 degrees, psi=−38.2 degrees. The first atom at the N-terminus was placed at the origin, and the overall orientation was set to form a substantial incline with respect to the Z axis. The molecules were initialized with a rigid-body velocity of 10 Angstroms/picosecond (ps) in the +Z direction.

Simulations were performed separately, each running for 20 ps of simulated time using the IMAGIRO 1.1 platform (Protein Mechanics, Mountain View, Calif.), with the Radau5 implicit integrator (Hairer and Wanner, Solving Ordinary Differential Equations II, Springer Verlag, Heidelberg (1991)). Frames were generated every 0.1 ps and the visualization tool VMD (Theoretical and Computational Biophysics Group, University of Illinois at Urbana-Champaign; at http://www.ks.uiuc.edu/Research/vmd/) was used to generate the animation of the molecules' motion. Atomic parameters were obtained from the Amber95 force field (UCSF, San Francisco, Calif., at http://www.amber.ucsf.edu/amber/amber.html). Solvent electrostatics and other conservative effects were modeled using the implicit solvent Generalized Born/Solvent Accessible (GB/SA) method (Tsui and Case, Biopolymers, 56:275-291 (2001)).

Kinetic effects of solvent-solute interactions were modeled as described above. Impulses were applied every 2 ps to random directions generated 10 times per atom following the steps outlined in the flowcharts of FIGS. 6A and 6B. For purposes of visualization, thermal effects of the solvent were reduced by setting the temperature to 0.0001K (in an implicit solvent simulation, this does not cause the water to “freeze”, but simply eliminates thermal vibrations), leaving only the viscous effect caused by the relative velocity of the molecule through the solvent. In the “control” run, the directionality of the solvent-accessible surface of the solute molecule was not considered—all directions of impulses were used in simulating kinetic effects. In the “test” run, employing directional methods of the present invention, the random directions generated as described above were tested to see if they coincided with the solvent-accessible surface of the solute peptide. Only those directions that were geometrically-capable of interacting with the solvent-accessible solute surface were used in the generation of impulses. Scaling was employed in both methods so that the generated impulses had appropriate values for the desired temperature, which was gradually reduced to 0.0001K.

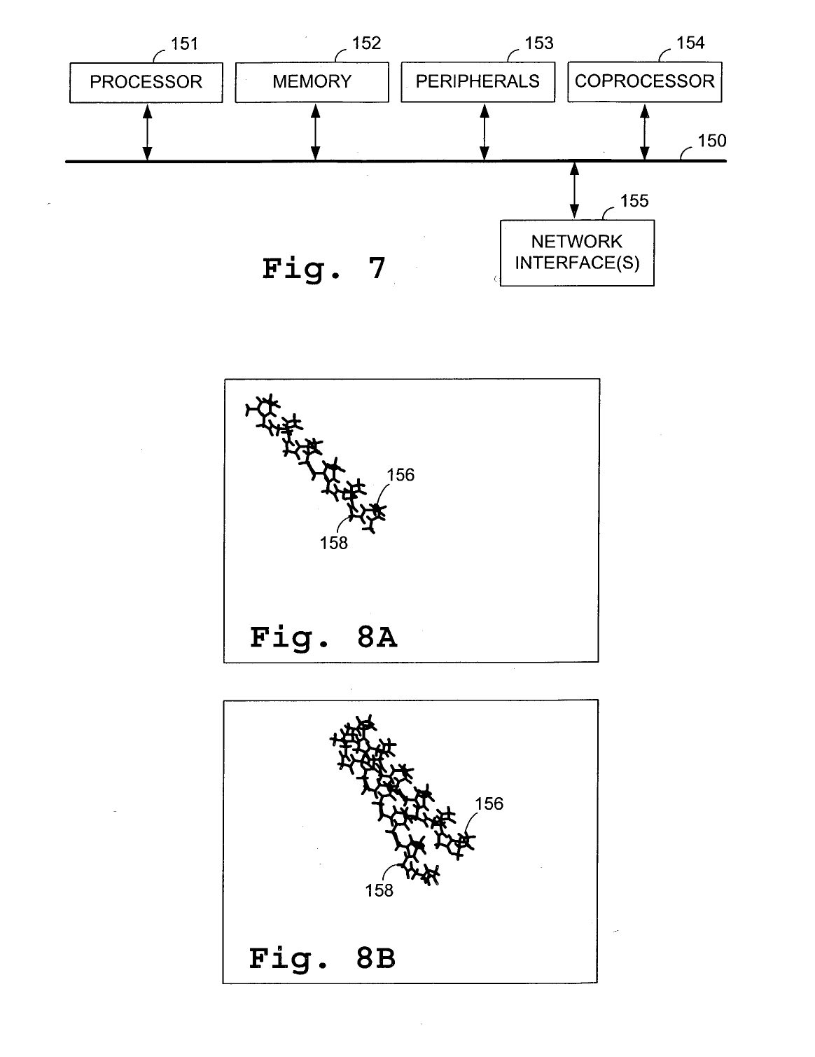

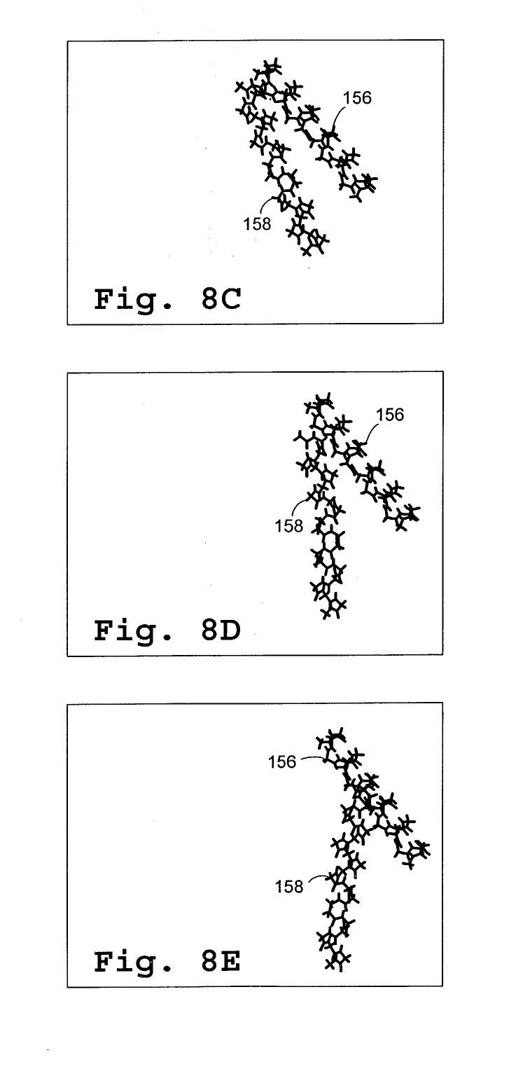

The results are shown in FIGS. 8A-8E. FIG. 8A shows control 156 and test 158 molecules at time zero. FIGS. 8B through 8E show molecules 156 and 158 at successive time points during the simulation (frame 25 in FIG. 8B; frame 50 in FIG. 8C; frame 100 in FIG. 8D; and frame 200 in FIG. 8E). It can be appreciated that as the simulation progresses, test molecule 158 experiences visible hydrodynamic behavior, in which the molecule's inclination with respect to its motion causes it to move in the −Y direction, as would be expected of an inclined plane moving through a fluid. In contrast, molecule 156, modeled using the conventional non-directional method, does not exhibit such hydrodynamic behavior and instead moves only in the +Z direction. Viscous effects are observed in both cases, so that both molecules 156 and 158 slow down and come to rest relative to the fluid. This shows that both methods produce plausible temperature control, but only the directional method does so while capturing physically meaningful hydrodynamic “steering” effects, which may be important in solving a variety of molecular dynamics problems, including protein structure and protein/ligand or protein/protein co-structures.

While the foregoing is a complete description of the embodiments of the invention, it should be evident that various modifications, alternatives and equivalents may be made and used. Accordingly, the above description should not be taken as limiting the scope of the invention which is defined by the metes and bounds of the appended claims.

What is claimed is:

1. A method of simulating kinetic behavior of a solute molecule in a solvent, comprising
(i) providing a representation of a solvent-accessible surface of said solute molecule, wherein said representation includes information on geometric orientation of said surface relative to said molecule, and
(ii) using said representation in a corrected kinetic model to simulate the kinetic behavior of said molecule in said solvent.

2. A method of claim 1, wherein said corrected kinetic model comprises applying one or more impulses to said solvent-accessible surface, and said impulses represent solvent-solute interactions.

3. A method of claim 1, wherein said corrected kinetic model comprises applying one or more forces to said solvent-accessible surface, and said forces represent solvent-solute interactions.

4. A method of claim 3, wherein said corrected kinetic model comprises a step of calculating total randomized forces ^{b}Rⱼ on patches corresponding to locations on said solvent-accessible surface.

5. A method of claim 1, wherein said representation comprises one or more solute molecule surface normal vector(s).

6. A method of claim 5, wherein said representation comprises one or more directional solvent-accessible surface(s).

7. A method of claim 5, wherein said corrected kinetic model comprises a step of calculating viscous collision speeds for locations on said solute molecule represented by said surface normal vectors.

8. A method of claim 5, wherein said corrected kinetic model comprises a step of calculating thermal collision speeds representative of solvent bath thermal kinetics.

9. A method of claim 8, wherein said thermal collision speeds are calculated using random speeds selected from a normal distribution centered about zero and having a standard deviation σ equal to k_{B}T/m_{b}.

10. A method of claim 1, wherein said simulating includes simulating kinetic behavior of two or more solute molecules simultaneously.

11. A method of claim 1, wherein said solvent is selected from the group consisting of an aqueous solvent and an organic solvent.

12. A method of claim 1, wherein said solvent is a lipid bilayer.

13. A method of claim 1, wherein said solvent is a non-uniform solvent.

14. A method of claim 1, wherein said solute molecule is a polymer.

15. A method of claim 14, wherein said solute molecule is selected from the group consisting of a polypeptide, a polynucleotide and a polysaccharide.

16. A method of claim 1, wherein said solute molecule is a small molecule.

17. A computer-implemented method of determining a directional solvent-accessible surface of an atom having a surface and neighboring atoms, said method comprising, in any computationally-feasible order,
(i) locating a point on or near the surface of said atom,
(ii) defining a surface normal vector at said point, and
(iii) assessing whether said point is inside of any of said neighboring atoms,
wherein a point not inside any neighboring atoms defines a collision point, and a surface normal vector at said collision point determines a directional solvent-accessible surface.

18. A method of claim 17, for determining a plurality of directional solvent-accessible surfaces of said atom, further comprising repeating steps (i) through (iii) one or more times, each time for a different point on or near the surface of said atom.

19. A method of claim 17, for determining collision points and directional solvent-accessible surfaces of a molecule comprising a plurality of said atoms, further comprising repeating steps (i) through (iii) one or more times for each atom of said plurality of atoms.

20. A method of claim 19, for simulating kinetic behavior of said molecule in a solvent, further comprising using said directional solvent-accessible surfaces in a corrected kinetic model to simulate said kinetic behavior of said molecule in said solvent.

21. A method of claim 20, wherein each of said collision points is used as a location at which a net collision speed in said corrected kinetic model is determined.

22. A method of claim 20, wherein said solvent is selected from the group consisting of an aqueous solvent and an organic solvent.

23. A method of claim 20, wherein said solvent is a lipid bilayer.

24. A method of claim 20, wherein said solvent is a non-uniform solvent.

25. A method of claim 20, wherein said solute molecule is a polymer.

26. A method of claim 25, wherein said solute molecule is selected from the group consisting of a polypeptide, a polynucleotide and a polysaccharide.

27. A method of claim 20, wherein said solute molecule is a small molecule.

28. A method for simulating kinetic behavior of a solute molecule in a solvent, comprising, in any computationally-feasible order,
(i) providing a set of surface normal vectors representing directional solvent-accessible surfaces of said solute molecule;
(ii) computing a dot product of vectors in said set with corresponding solute velocity vectors;
(iii) defining a distribution of speeds representing kinetic effects of solvent particles, and
(iv) using said dot product and said distribution to calculate kinetic forces on said solute molecule, said kinetic forces representing kinetic effects of said solvent on said solute molecule.

29. A method of claim 28, wherein said speeds are selected from a normal distribution centered about zero and having a standard deviation σ equal to k_{B}T/m_{b}.

30. A method of claim 28, wherein said simulating includes simulating the kinetic behavior of two or more solute molecules simultaneously.

31. A method of claim 28, wherein said solvent is selected from the group consisting of an aqueous solvent and an organic solvent.

32. A method of claim 28, wherein said solvent is a lipid bilayer.

33. A method of claim 28, wherein said solvent is a non-uniform solvent.

34. A method of claim 28, wherein said solute molecule is a polymer.

35. A method of claim 34, wherein said solute molecule is selected from the group consisting of a polypeptide, a polynucleotide and a polysaccharide.

36. A method of claim 28, wherein said solute molecule is a small molecule.

37. A method of estimating a solvent accessible surface area of a solute molecule comprising a plurality of atoms, each atom comprising a surface, said method comprising
(i) for each of said plurality of atoms, locating one or more points on the surface of said atom,
(ii) for each of said plurality of atoms, defining n geometrical objects, each object having a surface area, tangent to and on or near the surface of the atom and centered about one of said points, and
(iii) calculating what portion of each object is not inside the surface of any other atom to generate data,
wherein said data are used to estimate the solvent accessible surface area of said molecule.

38. A method of claim 37, further comprising generating surface normal vectors at each of said points, wherein said geometrical objects and surface normal vectors form a representation of a solvent-accessible surface of said solute molecule.

39. A method of claim 37, wherein said geometrical objects are selected from the group consisting of caps and disks.

40. A method of claim 39, wherein the surface area of each of said caps or disks is 4πr²/n.

41. A method of claim 39, wherein said geometrical objects are disks, each disk having a disk surface area, and wherein said disks are positioned such that one half of said disk surface area is inside the atom and one half of said disk surface area is outside the atom.
